(19) United States
(12) Patent Application Publication
(10) Pub. No.: US 2014/0203519 A1
(43) Pub. Date: Jul. 24, 2014

(54) SEAL PROTECTION SYSTEM

(71) Applicant: Caterpillar Inc., Peoria, IL (US)

(72) Inventors: ABHISHEK KUMAR GAURAV, CHENNAI (IN); ABHISHEK KUMAR MISHRA, CHENNAI (IN); ANTONY GRIEG JOSEPH, CHENNAI (IN)

(73) Assignee: Caterpillar Inc., Peoria, IL (US)

(21) Appl. No.: 14/224,286

(22) Filed: Mar. 25, 2014

(51) Int. Cl. F16J 15/16

(52) U.S. Cl. CPC F16J 15/16
USPC 277/500

(57) ABSTRACT

A seal protection system for use with protecting a seal assembly between a motor housing and a final drive assembly. The seal protection system includes a seal protector assembly having a first band portion and a second band portion. The first band portion is removably attached to the second band portion. Further, a compressible element is provided as a continuous resilient layer along an outer edge section of the first and second band portions. The first band portion and the second band portion are structured and arranged in a manner to overlay the seal assembly in a first position. Moreover, the first band portion and the second band portion are structured and arranged to separate relative to the seal assembly in a second position. In addition, the compressible element is disposed between the first and second band portions and one of the motor housing or the final drive assembly.

### TECHNICAL FIELD

The present disclosure relates generally to a final drive assembly of an earth moving machine. More specifically, the present disclosure relates to a seal protection system for use with protecting a seal assembly between a motor housing and the final drive assembly.

### BACKGROUND

Construction machines such as backhoe loaders and excavators are commonly used to perform common operations such as excavation, trenching, and many other types of earth moving and work tool operation. Usually, construction machines are used at places like crusher sites, landfills, forestry work, demolition and other environments, where debris and other foreign particles gets deposited around the final drive assembly of the construction machine during operation. Deposited debris along with other foreign particles penetrates into open areas between rotating members and seals at the final drive assembly. With time, the deposited debris destroys the seals and lubrication fluid leaks out leaving the rotating parts therein without adequate lubrication.

In some currently available final drive assemblies, open partial labyrinth type sealing arrangements are used to avoid accumulation of mud on the housing. However open partial labyrinth seal arrangements, although effective to prevent penetrating liquids and slurries, are less effective against preventing materials such as pebbles of smaller size such as pebbles ranging in size of 6 mm to 20 mm in entering between the housing and final drive assembly and compromising the seal. The entry of small size pebbles may lead to failure of the seal, loss of lubrication fluid and premature wear of the final drive housing.

### SUMMARY OF THE DISCLOSURE

The present disclosure provides a seal protection system for use with protecting a seal assembly between a motor housing and a final drive assembly. The seal protection system includes a seal protector assembly. The seal protector assembly includes a first band portion and a second band portion. The first band portion being removeably mounted to the second band portion. Further, a compressible element attached to the first and second band portions is provided. The compressible element provides a continuous resilient layer along an outer edge portion of the first and second band portions. Furthermore, the first band portion and the second band portion are structured and arranged in a manner to overlay the seal assembly coinciding with a first position of the seal protector assembly. Moreover, the first band portion and the second band portion are structured and arranged to separate relative to the seal assembly coinciding with a second position of the seal protector assembly. In addition, the compressible element being disposed between the first and second band portions and one of the motor housing or the final drive assembly coinciding with the first position of the seal protector assembly.

### BRIEF DESCRIPTION OF THE DRAWING

FIG. 1 illustrates a side view of an earth moving machine in accordance with the present disclosure;

FIG. 2 illustrates a perspective view of a undercarriage assembly of FIG. 1, with motor housing and final drive assembly which is a key component to drive the track assemblies of the earth moving machine;

FIG. 3 illustrates an exploded view of a seal protection system in accordance with the present disclosure;

FIG. 4 illustrates an assembled perspective view of the seal protection system of FIG. 3 in accordance with the present disclosure;

FIG. 5 illustrates a sectional view along line A-A of FIG. 4, depicting the compressible element radially extending from the band portion of the seal protection system in accordance with the present disclosure; and

FIG. 6 illustrates a sectional view of the motor housing, final drive assembly of FIG. 2, depicting the seal assembly and seal protection system.

### DETAILED DESCRIPTION OF THE DRAWINGS

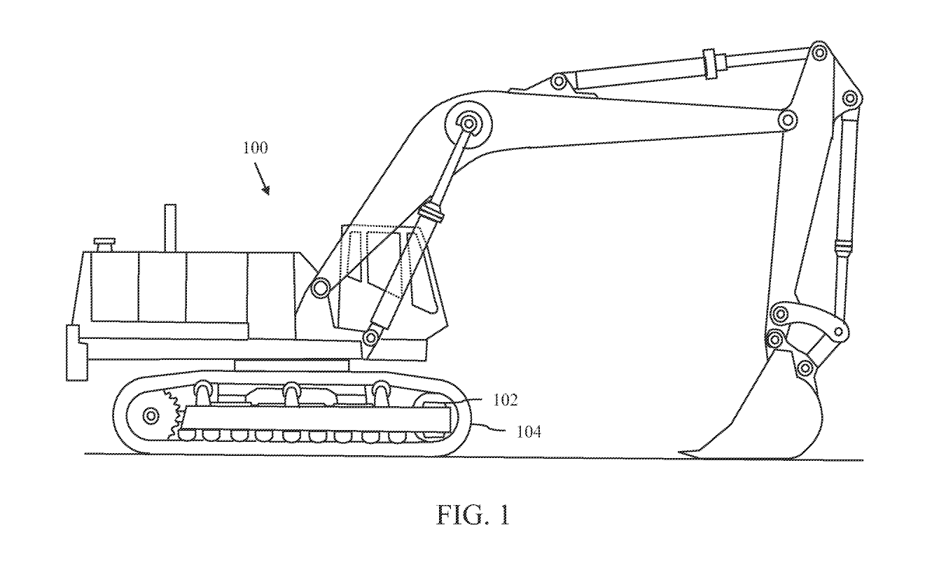

Referring to FIG. 1, the earth moving machine 100 includes an undercarriage assembly 102. The undercarriage assembly 102 includes a pair of continuous track assemblies 104 which supports the weight of earth moving machine 100 and engages the ground to propel the machine 100. The earth moving machine 100 moves by driving the pair of continuous track assemblies 104 by the undercarriage assembly 102.

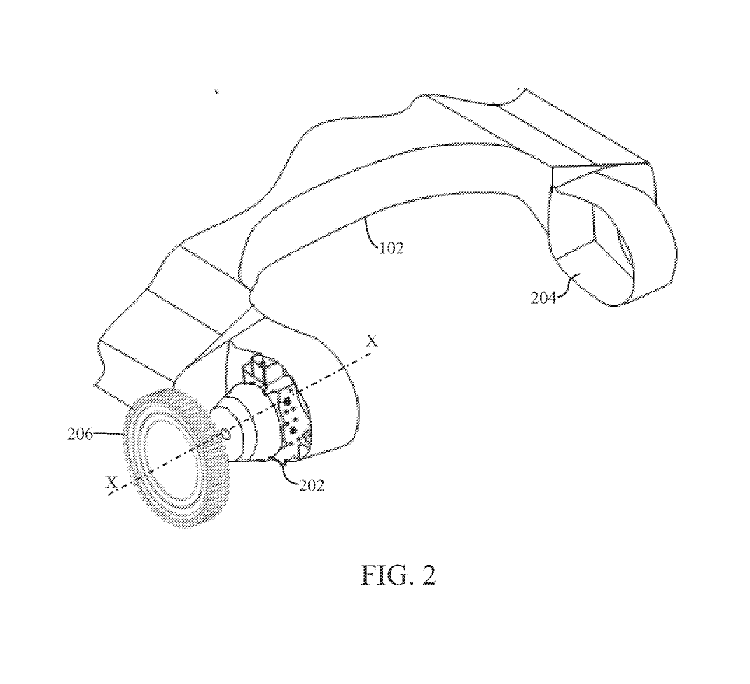

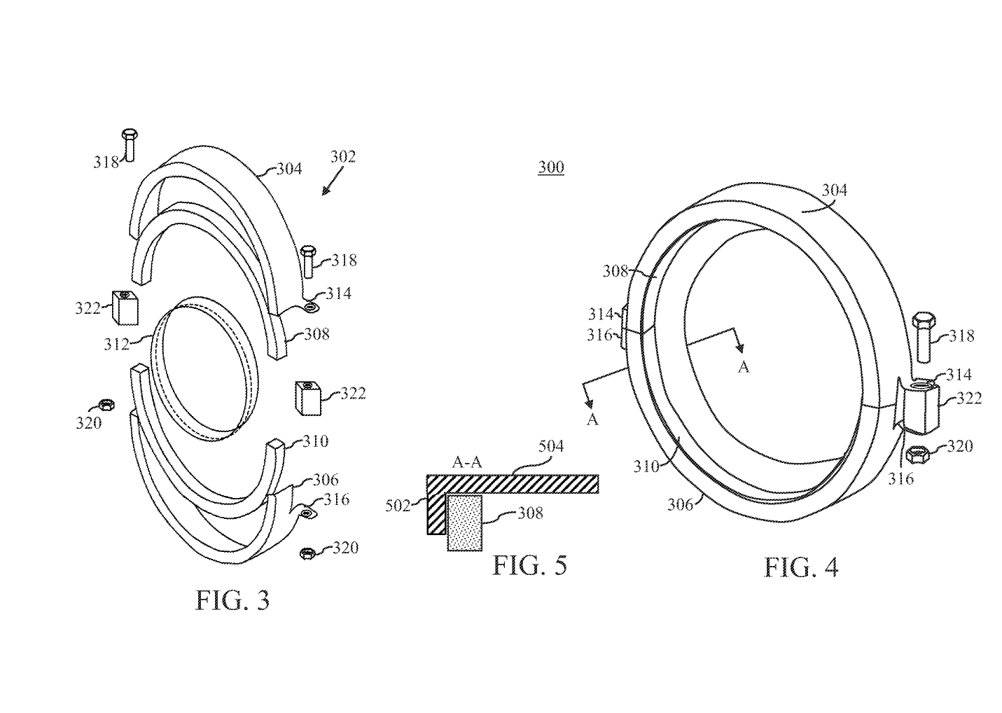

Referring to FIG. 2 one end of the motor housing 202 is positioned inside final drive housing 204 of the undercarriage assembly 102. The other end of the motor housing 202 is attached to the final drive assembly 206 in manner such that the final drive assembly 206 partially overlaps the motor housing 202, thereby forming an annular seam (not shown). A seal is provided around the seam where the final drive housing 206 overlaps the motor housing 202. The motor housing 202 includes lubrication oil to facilitate lubrication of the various moving components associated with drive mechanism (not shown) with in the final drive housing 204 and the seal provides for sealing the interior space from external environment and confine lubrication oil within the motor housing 202 to lubricate the drive mechanism. In an exemplary embodiment a duo cone seal (as shown in FIG. 3) is provided to seal the lubricant inside the motor housing 202. The motor housing 202 and the final drive assembly 206 are aligned with respect to axis X-X (FIG. 2) and sealed with the duo cone seal. Moreover, the final drive assembly 206 can be rotate about the rotational axis X-X.

Referring to FIG. 3, a seal protection system 300 includes a seal protector assembly 302 including a semi-circular first band portion 304 and a second band portion 306. The first band portion 304 is attached with a first compressible element 308 and the second band portion 306 is attached with a second compressible element 310.

The first band portion 304 and the second band portion 306 together form a clamp type band (as shown in FIG. 4) when assembled over the bolted circular portions of the adjacently positioned motor housing 202 and final drive assembly 206. The first band portion 304 and the second band portion 306 overlay a seal assembly 312 when assembled in a first position. The seal assembly 312 is provided to seal the interior space within the motor housing 202. The first band portion 304 and the second band portion 306 are sized wide enough to overlay the seal assembly 312 in the first position and may be separated relative to the seal assembly 312 in the second position. The first band portion 304 and the second band portion 306 may be separated from one another and relative to the seal assembly 312 in a disassembled or second position. The seal protector assembly 302 is further described in FIG. 4 and FIG. 5.

Referring to FIG. 4, the first band portion 304 of the seal protection system 300 covers a semi-circular half of an annular seam at the junction of the motor housing 202 and final drive assembly 206. Similarly, the second band portion 306 covers the other semi-circular half of the annular seam. Hence, the first band portion and the second band portion 306 together form a circular clamp type band. The first band portion 304 and the second band portion 306 together form a protective wrapping around the annular seam and the seal assembly 312. Further, the first compressible element 308 can be positioned in the circular space between the first band portion 304 and the seal assembly 312. Similarly, the second compressible element 310 can be positioned in circular space between the second band portion 306 and the seal assembly 312. Hence, the first compressible element 308 and the second compressible element 310 are disposed between the first and second band portions 304 and 306, and one of the motor housing 202 or the final drive assembly 206. Thereby, the first band portion 302, the second band portion 306 together with the first compressible element 308 and the second compressible element 310 forms a protective casing around the annular seam and the seal assembly 312.

Furthermore, the first band portion 304 includes a pair of first aperture 314 at each end of the first band portion 304. Similarly, the second band portion 306 includes a pair of second aperture 316 at each end of the second band portion 306. The pair of first aperture 314 and the pair of second aperture 316 are used to fasten the first band portion 304 with the second band portion 306 to form a circular clamp. A fastening means, for example a nut and bolt arrangement 318 and 320 can be assembled through the pair of first aperture 314 and the second aperture 316 to fasten the first band portion 304 and the second band portion 306. Hence, the first band portion 304 can be removeably assembled with the second band portion 306. In an embodiment, a pair of spacer element 322, which can be connected to final drive housing by welding, is provided for assembling the first band portion 304 and the second band portion 306. The spacer element 322 can be positioned between the pair of first aperture 314 and the pair of second aperture 316. Thereafter, the nut bolt assembly 318 and 320 can be passed through the pair of first and second aperture 314, the spacer element 322 and the pair of second aperture 316 to removeably mount the first band portion 304 to the second band portion 306.

Referring to FIG. 5, the first band portion 304 and the second band portion 306 of the seal protector assembly 302, have L shaped cross-section. In an exemplary embodiment, the first band portion 304 and the second band portion 306 are primarily manufactured from a sheet of metal formed to create an L shaped cross section however curved to match with the curvature of the motor housing 202 and the final drive assembly 206. It may be contemplated that any suitable method and material can be used to manufacture the first band portion 304 and the second band portion 306, the current example is in no way limiting.

The first band portion 304 includes an outer edge section 502 extended radially and an inner edge section 504 extended in the axial direction. The compressible element 308 is attached at a corner of the outer edge section 502 and the inner edge section 504. The thickness of the compressible element 308 extends beyond the length of the outer edge section 502 and forms a continuous resilient layer along the perimeter of the first band portion 304. In one embodiment, the first compressible element 308 can be attached to the first band portion 304 by using a suitable adhesive material. In another embodiment, the first compressible element 308 can be snap fitted inside the corner of the inner edge section 502 and outer edge section 504. The compressible element 308 extends radially from the first band portion 304 to take up space as it is compressed and fitted over the seam at the mating surface of the motor housing 202 and the final drive assembly 206. The compressible element 308 acts like a dust seal element compressing around a shaft. The shape, cross section and arrangement of the second band portion 306 and the second compressible element 310 is similar to the first band portion 304 and the first compressible element 308, respectively.

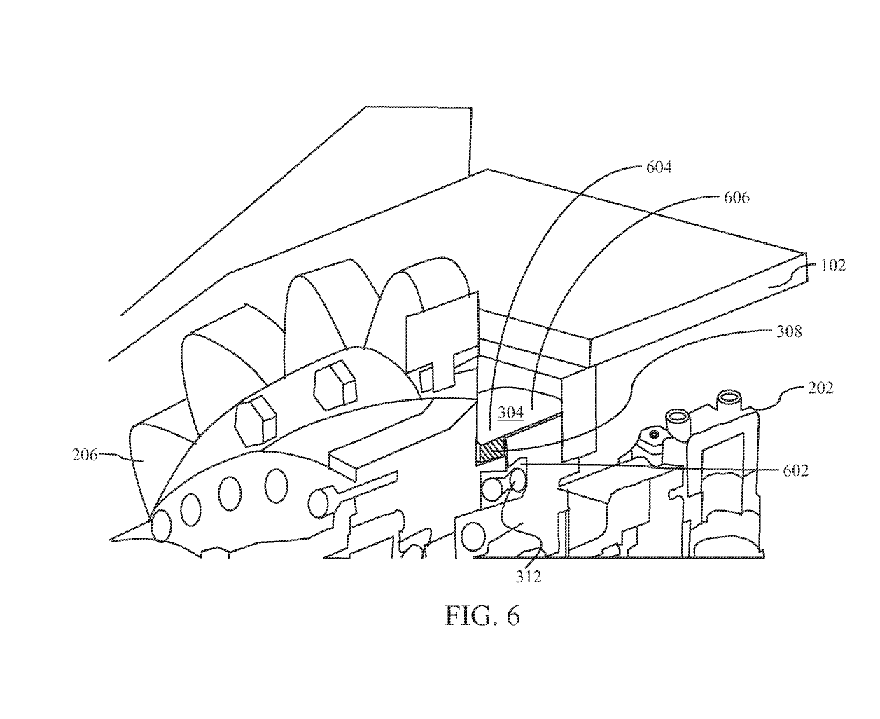

Referring to FIG. 6, the final drive assembly 206 when coupled with the motor housing 202 defines an annular grove 602 at the seam. Specifically, the annular groove 602 is formed at the junction of inner periphery of the final drive assembly 206 and outer periphery of the motor housing 202. The seal assembly 312 is positioned within the annular groove 602. As described earlier the interior space may be partially filled with lubricating oil to facilitate lubrication of the various moving components associated with drive mechanism of the undercarriage assembly 102 for the machine 100. The seal assembly 312 is provided to seal the interior space from external environment and confine lubrication oil within the motor housing 202 to lubricate the drive mechanism. In an exemplary embodiment, the seal assembly 312 is a duo cone seal provided to protect leakage of interior lubricating oil and entry of any external debris.

Further, the seal protection system 300 for use with protecting the seal assembly 312 between the motor housing 202 and a final drive assembly 206 is described. The seal protector assembly 302 is mounted in a peripheral orientation relative to the seal assembly 312 so as to form an annularly positioned barrier which extends circumferentially about the seal assembly 312 within the annular groove 602. The first band portion 304 and the second band portion 306 (not shown) are removably assembled (as shown in FIG. 3 and FIG. 4) to circumscribe the annular groove 602. The first band portion 304 and the second band portion 306 are arranged in manner so as to overlay the seal assembly 312 in a first position 604. In the first position 604, the outer edge 502 of the first band portion 304 overlay the seal assembly 312. Further, as shown in FIG. 6 the compressible element 308 is disposed between the final drive assembly 206 and the first band portion 304. In an alternate embodiment, the compressible element 308 can be sandwiched between the motor housing 202 and the first band portion 304. Furthermore, in a second position 606, the outer edge 504 of the first band portion 304 is arranged separate relative to the seal assembly 312 and thereby along with the compressible element 308 prevent any dust or debris reach the seal assembly 312. Hence, the first band portion 304 along with the compressible element 308 provides a protective covering around the seal assembly 312. It can be contemplated that the second band portion 306 and the second compressible element 310 can be arranged in a manner similar to the first band portion 304 and the first compressible element 308.

### INDUSTRIAL APPLICABILITY

The present disclosure is applicable to final drives for an earth moving machine 100 that may be operated in environments for applications like land fill, forestry, demolition and other applications that include debris and other foreign particles. The earth moving machine 100 can be any machine used in construction site, mining site or land filling site. Examples of the earth moving machine can include cold planer, mining machine, excavator, a track type tractor, dozer, loader, tractor- scraper, underground mining machine, skid steer loader, off—highway truck, skidders, road reclaimer, industrial loader, wheel compactor, feller buncher and the like. The debris and other foreign particles may get deposited and wear the seal assembly 312 on the final drive assembly 206. Although the final drive assembly 206 of the present disclosure is illustrated in the context of the earth moving machine 100, it can find application for other machines that include final drives assemblies.

When in operation, the motor housing 202 of the undercarriage assembly 102 is in coupling with the final drive assembly 206. The final drive assembly 206 will rotate with respect to the motor housing 202 about the rotation axis X-X. The seal assembly 312 to be protected is positioned at the annular grove 602 between the final drive assembly 206 and the motor housing 202. The seal assembly 312 is protected from debris by the seal protection system 300 positioned around the annular groove 602 defined by the area between the motor housing 202 and the final drive assembly 206. The first band portion 304, attached with the first compressible element 308, is positioned over a semi-circular region of the seal assembly 312. Similarly, the second band portion 306, attached with the second compressible element 310, is positioned over the rest of the semi-circular region of the seal assembly 312. Thereafter, a fastening means such as the nut and bolt assembly 318 and 320 is used to removeably attach the first band portion 304 with the second band portion 306. Therefore, the seal protection system 300 provides an annular covering around the seal assembly 312 and thereby providing a protection to the seal assembly 312. This protection is enhanced by the use of the first compressible element 308 and the second compressible element 310.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A seal protection system for use with protecting a seal assembly between a motor housing and a final drive assembly, the seal protection system comprising:
a seal protector assembly including a first band portion and a second band portion, the first band portion being removeably mounted to the second band portion;
a compressible element attached to the first and second band portions and providing a continuous resilient layer along an outer edge portion of the first and second band portions,
wherein the first band portion and the second band portion are structured and arranged to:
overlay the seal assembly coinciding with a first position of the seal protector assembly, and
separate relative to the seal assembly coinciding with a second position of the seal protector assembly,
wherein the compressible element being disposed between the first and second band portions and one of the motor housing or the final drive assembly coinciding with the first position of the seal protector assembly.
